(19) United States
(12) Patent Application Publication
(10) Pub. No.: US 2024/0232665 A1
(43) Pub. Date: Jul. 11, 2024

(54) ATTRIBUTE INFERENCE METHOD FOR CO-TRAINING DATA, COMPUTING DEVICE, AND STORAGE MEDIUM THEREOF

(71) Applicant: DONGGUAN UNIVERSITY OF TECHNOLOGY, DONGGUAN (CN)

(72) Inventors: YI WANG, DONGGUAN (CN); HAOXIN YANG, DONGGUAN (CN); BIN LI, DONGGUAN (CN)

(21) Appl. No.: 18/613,118

(22) Filed: Mar. 22, 2024

Related U.S. Application Data
(63) Continuation of application No. PCT/CN2021/135055, filed on Dec. 2, 2021.

(51) Int. Cl. G06N 5/046; G06N 3/0464

(52) U.S. Cl. CPC G06N 5/046; G06N 3/0464

(57) ABSTRACT

An attribute inference method for co-training data includes: distributing a pre-trained share model to a participating device in distributed co-training; acquiring a first gradient uploaded by the participating device; reconstructing a deep feature of the sample data based on the first gradient by using the updated share model; extracting a deep feature of assistance data with an attribute label by using the share model, and training an attribute inference model; and inferring a data attribute of an individual local training sample of the participating device based on the trained attribute inference model and the reconstructed deep feature.

### CROSS-REFERENCE TO RELATED APPLICATIONS

This application is a continuation of International Application No. PCT/CN2021/135055, with an international filing date of Dec. 2, 2021, the entire contents of which are incorporated herein by reference.

### TECHNICAL FIELD

The present disclosure relates to the technical field of machine learning, and in particular, relates to an attribute inference method for co-training data, and a computing device and a storage medium thereof.

### BACKGROUND

With the rapid development of hardware devices and the promotion of big data, artificial intelligence is extensively concerned. Deep learning, as an important data analysis tool, has been widely used in biometric identification, automobile automatic driving, machine vision, and the like application fields. In training for deep learning, centralized training and distributed training are involved. In centralized training, a center server collects data desired by the training and then performs centralized training. In the distributed training (also referred to as co-training), data does not need to be collected, and instead a model is trained in a local device (hereinafter referred to as a participating device) based on the local data of participants in distributed training, and then a gradient for training or parameter information of the model is sent to the center server for aggregation to achieve an object of distributively training the same model.

In co-training, data distribution of the participants in the training is typically unbalanced. In this way, the locally trained model may be subject to some deviations, and thus performance of the co-trained model is degraded. In addition, in deep learning, the performance of the model may be maximized on the premise that an application scenario of the model is similar to data distribution of the model. By statistical collection of attributes of the training data, the model may also be deployed to a more suitable application scenario. In the related arts, generally the attribute of each individual local sample of the participating device may be inferred by reconstructing updated sample data for co-training, and this attribute inference method is only applicable to the scenario where the participating device uses a single or extremely small-batch sample data for iterative updates but fails to accommodate co-training. The other attribute inference methods based on gradient update fail to acquire the data attribute of an individual training sample in the entire batch, and thus the effectiveness of inference is poor.

### SUMMARY

Embodiments of the present disclosure provide an attribute inference method for co-training data. The method includes: distributing a pre-trained share model to a participating device in distributed co-training, such that the participating device iteratively trains and iteratively updates the share model by using batch data of a local sample; acquiring a first gradient uploaded by the participating device, wherein the first gradient is a gradient that is calculated relative to a model parameter during model training by the participating device; reconstructing a deep feature of the sample data based on the first gradient by using the share model; extracting a deep feature of assistance data with an attribute label by using the share model, and training an attribute inference model, wherein the share model is acquired by co-training and a plurality of iterative updates; and inferring a data attribute of the reconstructed deep feature based on the trained attribute inference model.

Embodiments of the present disclosure further provide a computing device. The computer device includes: a processor, a memory, a communication interface and a communication bus; wherein the processor, the memory and the communication bus communicate with each other via the communication bus; and the memory is configured to store at least one executable instruction, wherein the at least one executable instruction, when loaded and executed by the processor, causes the processor to perform the attribute inference method for co-training data as described above.

Embodiments of the present disclosure further provide a computer-readable storage medium. The storage medium stores at least one executable instruction; wherein the executable instruction, when loaded and executed by a processor, causes the processor to perform the operations corresponding to the attribute inference method for co-training data as described above.

### BRIEF DESCRIPTION OF THE DRAWINGS

One or more embodiments are illustratively described by using a diagram that corresponds to the one or more embodiments in the accompanying drawings. These exemplary descriptions do not constitute any limitation on the embodiments. Elements that have the same reference numerals in the accompanying drawings are represented as similar elements. Unless specifically indicated, the diagrams in the accompanying drawings do not constitute any limitations on proportions.

FIG. 1 is a gender characteristic diagram of sample data of a face classification model;

FIG. 2 is a schematic diagram of an application scenario according to an embodiment of the present disclosure;

FIG. 3 is a schematic flowchart of an attribute inference method for co-training data according to an embodiment of the present disclosure;

FIG. 4 is a schematic structural diagram of a share model;

FIG. 5 is a schematic statistical diagram of success rates of deep feature reconstruction under different batch sizes of sample data according to the present disclosure and the related art 1;

FIG. 6 is a schematic structural diagram of an attribute inference apparatus for co-training data according to an embodiment of the present disclosure; and

FIG. 7 is a schematic structural diagram of a computing device 600 according to an embodiment of the present disclosure.

### DETAILED DESCRIPTION

For clearer descriptions of the objects, technical solutions, and advantages of embodiments of the present disclosure, the embodiments of the present disclosure are described in detail with reference to accompanying drawings. However, persons of ordinary skill in the art may understand, in the embodiments of the present disclosure, more technical details are provided for readers to better understand the present disclosure. However, even though these technical details and various variations and modifications based on the embodiments hereinafter, the technical solutions of the present disclosure may also be practiced.

With rapid development of hardware devices and promotion of big data, artificial intelligence is extensively concerned. Deep learning, as an important data analysis tool, has been widely used in biometric identification, automobile automatic driving, machine vision, and the like application fields.

In training for deep learning, centralized training and distributed training are involved. In centralized training, a center server collects data desired by the training and then performs centralized training. In the distributed training (also referred to as co-training or co-learning), a plurality of participants collaboratively train a machine learning model based on local data thereof. In this process, the participants neither need to collect data, nor need to exchange the local data thereof, but needs to train a model in a local device based on the local data thereof, and then send the gradient for training and parameter information of the model to the center server for aggregation. That is, the participants exchange therebetween gradient information for model parameter update to achieve an object of distributively training the same model. In co-training, since the participants do not need to upload the local data, data privacy is ensured, and thus data security is high.

In co-training, data distribution of the participants in the training is typically unbalanced. For example, in co-training of a face recognition model, in data of different participants in the training, gender ratios of males to females may be different. In this way, the locally trained model may be subject to some deviations, and thus performance of the co-trained model is degraded. With statistical collection of the gender ratios of males to females in the participants in the training, constraints may be added for the local model based on data distribution of the gender ratios, such that the performance of the model is improved.

In addition, in deep learning, the performance of the model may be maximized on the premise that an application scenario of the model is similar to data distribution of the model. By statistical collection of attributes of the training data, the model may also be deployed to a more suitable application scenario. For example, in a co-trained face recognition model, where data of the participants is mostly data of the young, it is improper to the data to an application mostly dedicated to the hold. By statistical collection of the attributes of the training data, the model may also be deployed to a more suitable application scenario or corresponding deployment may be carried out upon tuning of the model.

In deep learning, features extracted by models trained based on different learning tasks are generalized. That is, features extracted from one task may be applied to learning of another task. In summary, for improvement of the performance of the model and for deployment of the model to a more suitable application scenario, in co-training, distribution and related attributes of the training data need to be inferred. Since deep features not only contains information related to primary tasks of co-training, but also contains other extra information, related inference may be made to the data based on the deep features.

In the related art 1, data attributes are inferred based on inter-layer features acquired by forward propagation of the model or probabilities finally output. By this method, based on data with attribute labels, features or probabilities output by the model are acquired by forward propagation of the model, and then an attribute inference classifier is trained based on such information, and hence the related attributes of the data are inferred. Such data attribute inference approaches are mostly applied in scenarios of machine leaning as a service. In this scenario, mostly a trained model is queried based on the data, but updating the model parameter or re-deploying the model based on the data of the participants is not involved. In addition, generally, such methods typically need to modify the training process of the model, such that the interlayer output or the finally output code of the model contains information related to the data attributes.

In the related art 2, the data attributes are inferred based on the gradient in back propagation of the model. By this method, data with data labels is input into the model, a loss gradient corresponding to the data is calculated, and an attribute inference classifier is trained based on information of the gradient, such that related attributes of the data are inferred. In training for deep learning, mini-batch training is commonly used. That is, in a training process, a plurality of data is input, and then an average gradient corresponding to the plurality of data is calculated. The gradient distributed in co-training is acquired by weighted averaging on gradients of the plurality of data. Therefore, such methods are only capable of determining an average attribute of data in an entire batch, but incapable of acquiring an attribute of a single data point.

In the related art 3, original training data is reconstructed based on a gradient uploaded by a sub-model during co-training. By this method, randomly initialized training data is input into a model, a loss gradient corresponding to the data is calculated, and a difference between the loss gradient and the uploaded gradient is minimized, such that the randomly initialized training data is optimized. In this way, the original training data is reconstructed, and the training data is applied to attribute inference. In this method, due to the model structure and the back size of the training data, the effect of data reconstruction is affected, and consequently, data inference based on the reconstructed data is not accurate.

Therefore, embodiments of the present disclosure provide a technical solution. Deep features of training data are reconstructed based on gradient information distributed in co-training, and additional information inference is performed for the data based on the deep features, such that distribution and related attributes of the training data are inferred, parameter configuration in co-training is adjusted, and a trained model is better deployed in an actual scenario.

In related art 1, during data attribute inference, generally, such methods typically need to modify the process of training the model, such that the interlayer output or the finally output code of the model contains information related to the data attributes. Modifying the model training process is infeasible in co-training, because all the participants need to have a common learning target. If an individual participant modifies the training process, the training effect of the entire model is affected. According to the embodiments of the present disclosure, deep features are reconstructed based on gradients, and attributes of each of training data is inferred based on the reconstructed deep feature. In this way, the data attributes may be inferred without modifying the process of training the model.

In the related art 2, in attribute inference based on the gradient information experience weighted averaging, an average attribute of a batch of data is only inferred, instead of accurately inferring the attribute of a specific piece of data. According to the embodiments of the present disclosure, the deep feature corresponding to each data point is reconstructed based on the gradient, and then the attribute of the data is inferred based on the reconstructed deep feature. In this way, the attribute of a specific piece of data may be accurately inferred.

In the related art 3, due to the model structure and the back size of the training data, the effect of data reconstruction is affected, and consequently, data inference based on the reconstructed data is not accurate. According to the embodiments of the present disclosure, some sub-blocks of a model are used as the model structure, the model structure is simpler, and the task of reconstructing the deep feature is simpler than the task of reconstructing the original data. Therefore, by reconstruction of the deep feature using the method according to the embodiments of the present disclosure, the impacts from complex model structure are prevented, a reconstruction effect achieved in case of large-batch sample data is prominent and stable.

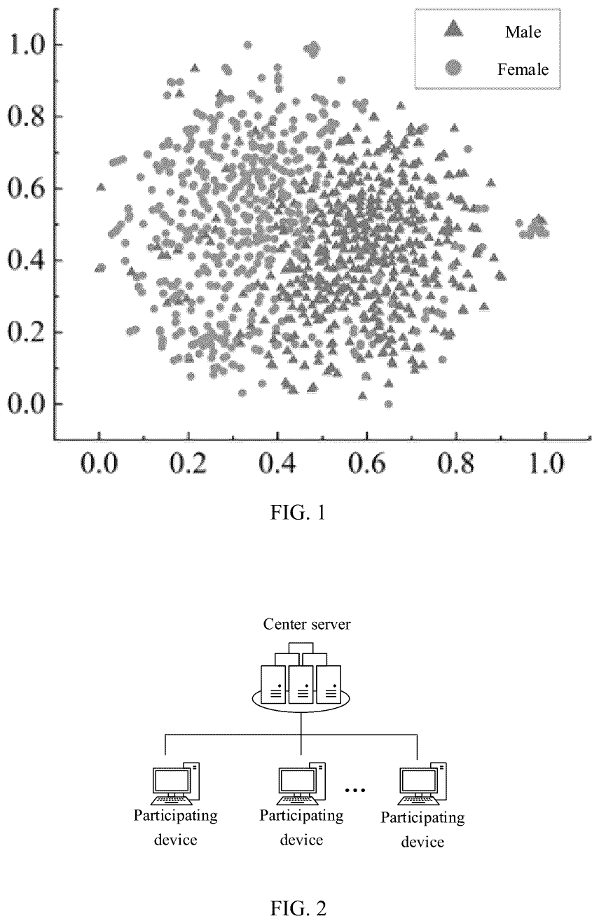

FIG. 1 is a gender characteristic diagram of sample data of a face classification model. The t-distributed stochastic neighbor embedding (T-SNE) algorithm higher-dimension features to two dimensions, and then normalizes coordinates to be between 0 and 1. The values obtained upon normalization of the abscissa and ordinate in FIG. 1 have no specific meanings. A major task of training a common face classification model is to determine identification information of a person, and gender information is not provided in the process of training a model. However, as illustrated in FIG. 1, it may be seen that even if no gender information is provided, in the case that the feature extracted by the model are subjected to T-SNE dimension reduction visualization, the features extracted from male and female samples are somewhat different, and may be simply differentiated. Therefore, data attribute inference may be somewhat achieved based on the deep feature, which proves the possibility in data attribute inference based on the features of the model.

An application scenario of the embodiments of the present disclosure is co-training in deep learning. An object of co-training is to collaboratively train a model based on local data of participants involved in co-training, with the training data maintained locally at the participating devices. The deep learning model may be a neural network model, for example, a convolutional neural network (CNN) model. The deep learning model may be applied to data processing, for example, feature extraction and classification in image processing. Further, the deep learning model may be applied to face recognition, object recognition, and the like. In the object recognition, an animal, a plant, an article, or the like may be recognized.

FIG. 2 is a schematic diagram of an application scenario according to an embodiment of the present disclosure. As illustrated in FIG. 2, a center server distributes a share model to be involved in co-training to participating devices (or referred to as training devices) of participants in co-training, and the participating devices perform model training based on locally stored training data thereof. The participating device sends a gradient for training or parameter information of the model to the center server for aggregation, and finally completes model training. For improvement of the efficiency of co-training and prevention of a greater difference, the share model is generally pre-trained on a public data set at a server. The public data set is generally considered to have different samples from all the participating devices in co-training but have similar data distribution.

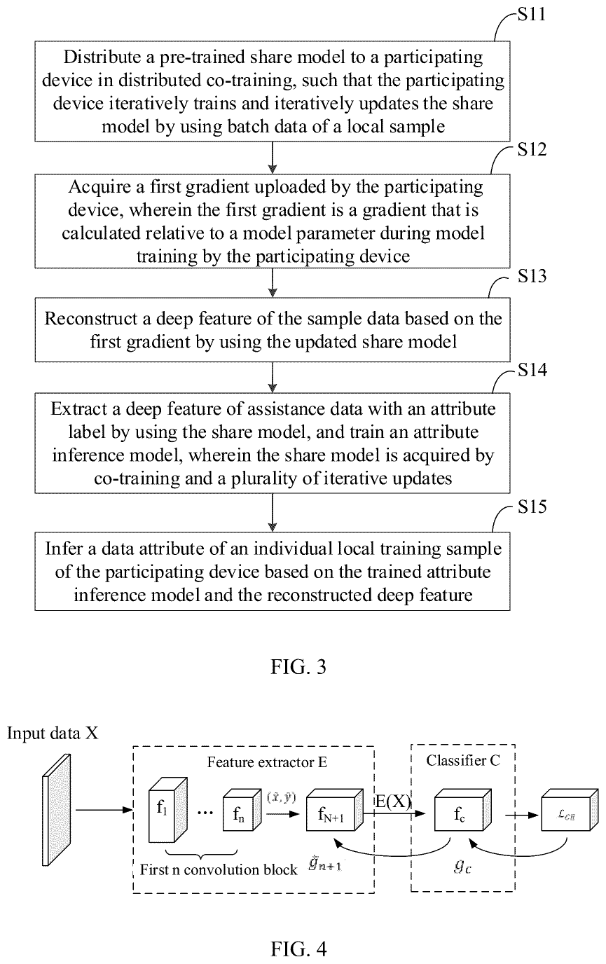

FIG. 3 is a schematic flowchart of an attribute inference method for co-training data according to an embodiment of the present disclosure. The method is applicable to a center server for model distributed co-training. As illustrated in FIG. 3, the method includes the following steps:
S11, distributing a pre-trained share model to a participating device in distributed co-training, such that the participating device iteratively trains and iteratively updates the share model by using batch data of a local sample;
S12, acquiring a first gradient uploaded by the participating device, wherein the first gradient is a gradient that is calculated relative to a model parameter during model training by the participating device;
S13, reconstructing a deep feature of the sample data based on the first gradient by using the updated share model;
S14, extracting a deep feature of assistance data with an attribute label by using the share model, and training an attribute inference model ƒₐₜₜᵣ, wherein the share model is acquired by co-training and a plurality of iterative updates; and
S15, inferring a data attribute of an individual local training sample of the participating device based on the trained attribute inference model ƒₐₜₜᵣ and the reconstructed deep feature.

According to the embodiments of the present disclosure, the gradient that is calculated relative to the model parameter during model training by the participating device is acquired, the deep feature of the sample data is reconstructed based on the gradient and the share model, and the attribute inference model ƒₐₜₜᵣ is trained based on the deep features of the assistant data with the attribute label, and finally attribute inference is performed for the reconstructed deep features based on the trained attribute inference model ƒₐₜₜᵣ. Additional attribute inference may be performed based on redundant features contained in the reconstructed deep features, and the related attribute of each piece of sample data is inferred with no need of reconstructing the input sample, free of impacts from a batch size of the sample data updated by the participating device each time during training. Particularly, a reconstruction effect achieved in case of large-batch sample data is prominent and stable, and the data attribute of the individual local training sample of the participating device is inferred.

The co-training according to the embodiments of the present disclosure is briefly described. The center server distributes a first share model (that is, an initialization model) to all the participating devices. Each of the participating devices randomly selects a batch of sample data from the locally stored sample data for model training. Upon completion of training, the participating device sends the model parameter updated in the training to the center server. The center server acquires an optimized second share model by averaging the model parameters updated by all the participating devices. The center server continues to distribute the second share model to all the participating devices. The participating devices continue model training. In subsequent training, the participating device always randomly selects a batch of new local sample data for training. Upon iterative training for several times, finally a trained model that converges is acquired.

In S11, first, the center server initializes a model to be trained, and distributes the initialized share model to the participating devices involved in distributed co-training. Each of the participating devices locally stores the sample data for training the model, and the sample data stored on these participating devices is generally different and unbalanced. The model to be trained may be an image recognition model, and in this case, the data for training includes images. Upon each iteration, the center server distributes the updated share model to the participating devices.

FIG. 4 is a schematic structural diagram of a share model. As illustrated in FIG. 4, the share model is a convolutional neural network model for image recognition, and the share model includes a feature extractor E and a classifier C. The feature extractor E includes (n+1) convolution blocks, respectively represented by ƒ₁, ƒ₂, . . . , ƒₙ, ƒₙ₊₁, and the feature extractor E is configured to extract a feature E(X) of input sample data X. The classifier C includes a classification block ƒ_{C}, and is configured to recognize the extracted feature E(X). The sample data X (an image) is input into the feature extractor E, and the deep feature E(X) corresponding to the sample data X is acquired by convolution operations by the (n+1) convolution blocks. The deep feature E(X) is input into the classifier C, and a final image recognition result is acquired.

The participating device receives the share model distributed by the center server, and randomly samples a batch of data from the locally stored data. The participating device performs training locally, calculates a loss gradient g in back propagation corresponding to the randomly sampled data, and shares g to the center server for model co-training. Referring to FIG. 4, a loss gradient g may be calculated based on a loss function [symbol] _{CE}. The loss gradient g includes g_{c} and gₙ₊₁·g_{c} represents a gradient that is calculated for the loss function by the participating device relative to a parameter of ƒ_{c}, and gₙ₊₁ represents a gradient that is calculated for the loss function by the participating device relative to a parameter of ƒₙ₊₁. These two gradients are both real gradients. In this way, useful information is provided for subsequent attribute inference, which is particularly useful for training and update of large-batch sample data.

In some embodiments, the first gradient is a gradient that is calculated for a model loss in back prorogation, corresponding to a first sample set, relative to the model parameter by the participating device during model training on the first sample set randomly sampled by the participating device. Data in the first sample set may be small-batch data, and hence the calculation speed and efficiency may be improved. During randomly sampling the first sample set for model training by the participating device, in S13, the deep feature of the sample data is reconstructed based on the first gradient by using the updated share model;

The training data of the participating device is constantly maintained locally, and is not shared with other participating devices or servers. In this way, security and privacy of the training data are ensured. Mini-batch data includes a plurality of samples, and the number of samples is determined by a batch size. Each of the samples includes content related to a target model in co-training. For example, co-training is to collaboratively train a face recognition model, and each of the samples contains a face image and corresponds to a label. Content of the label is determined by the object of model co-training.

In some embodiments, S13 may further include:
S131: randomly initializing a first deep feature to be optimized;
S132: acquiring a second gradient by inputting the first deep feature into the share model; and
S133: optimizing the first deep feature by minimizing a difference between the first gradient and the second gradient.

Referring to FIG. 4, the share model is a convolutional neural network model and includes a feature extractor and a classifier ƒ_{c}, wherein the feature extractor includes (n+1) convolution blocks. The first deep feature is a data pair (\tilde{x}, \tilde{y}), which represents a pair of optimizable data, \tilde{x} represents a deep feature to be reconstructed, and \tilde{y} represents a pseudo label. Since the real label of the sample data (the original data) is unknown, herein an optimizable pseudo label needs to be provided for calculating a cross entropy loss. (\tilde{x}, \tilde{y}) is originally acquired by random initialization. Upon optimization, a reconstructed (\tilde{x}, \tilde{y}) finally acquired is similar to the original (\tilde{x}, \tilde{y}), and \tilde{x} represents the reconstructed deep feature.

In the embodiments of the present disclosure, information of a last convolution block ƒₙ+₁ and information of a last classifier ƒ_{c} need to be used. The data pair (\tilde{x}, \tilde{y}) is input into a sub-module constituted by ƒₙ+₁ and ƒ_{c} based on forward propagation information of ƒₙ+₁ and ƒ_{c} the back propagation information gₙ₊₁ and g_{c} corresponding to the two network layers, and gradients for the loss function relative to the parameters of ƒₙ+₁ and ƒ_{c} are respectively calculated. Specifically, S132 includes:
S1321: inputting the first deep feature into a last convolution block ƒₙ+₁ of the feature extractor, and inputting a feature E(X) output by the convolution block ƒₙ+₁ into the classifier ƒ_{c}; and

S1322: calculating a gradient \tilde{g}ₙ₊₁ of a parameter of a loss function corresponding to ƒₙ₊₁ and a gradient \tilde{g}_{c} of a parameter of the loss function corresponding to ƒ_{c};
wherein the second gradient includes a gradient \tilde{g}ₙ₊₁ and a gradient \tilde{g}c.

In some embodiments, the gradient \tilde{g}ₙ₊₁ and the gradient \tilde{g}_{c} are calculated in accordance with the following formula:

\tilde{g}_{c}=∇_{ƒ}_{_{C}} [symbol] _{CE}[ƒ_{c}(ƒₙ₊₁(\tilde{x})),\tilde{y}]

\tilde{g}ₙ₊₁=∇_{∇ƒn+1} [symbol] _{CE}[ƒ_{c}(ƒₙ+1(\tilde{x}),\tilde{y}]

wherein [symbol] _{CE} represents a cross entropy loss function. [symbol] fCrepresents a gradient operator (a total derivative in various directions of a space) of ƒ_{c}, and [symbol] Fₙ₊₁ represents a gradient operator of ƒₙ+1.

Since the gradients \tilde{g}_{c} and \tilde{g}ₙ₊₁ that are calculated based on the randomly initialized data pair (\tilde{x}, \tilde{y}) need to be matched with the real gradients g_{c} and gₙ₊₁, a target function may be designed to perform feature optimization. Minimizing the difference between the first gradient and the second gradient in S133 further includes:

minimizing a difference between the first gradient and the second gradient by minimizing a target function [symbol] , wherein the target function is:

[symbol]

=λ·d(gₙ₊₁,\tilde{g}ₙ₊₁)+d(g_{c},\tilde{g}_{c})

wherein λrepresents a hyper-parameter, gₙ₊₁ and g_{c} each represent the first gradient uploaded by the participating device, d(gₙ₊₁, \tilde{g}ₙ₊₁) and d(g_{c}, \tilde{g}_{c}) each represent a distance function for measuring the difference between two gradients, and the difference between two gradients g and g is measured by a distance function d:

$$d ( g , \tilde{g} ) = ( 1 - \frac{〈 g , \tilde{g} 〉}{‖ g ‖ \cdot ‖ \tilde{g} ‖} ) + ( 1 - exp ( \frac{- {‖ g - \tilde{g} ‖}^{2}}{{σ}^{2}} ) )$$

wherein δ²=Var(g), and Var(g) represents a variance of the gradient g.

The distance function d involves two calculation items. One is cosine similarity (

$$\frac{〈 g , \tilde{g} 〉}{‖ g ‖ \cdot ‖ \tilde{g} ‖} ,$$

and the other is Gaussian kernel function exp

$$( \frac{- {‖ g - \tilde{g} ‖}^{2}}{{σ}^{2}} ) .$$

Optimizing the first deep feature in S133 further includes:
updating (\tilde{x}, \tilde{y}) in accordance with the following formula:

(\tilde{x}ⱼ₊₁,\tilde{y}ⱼ₊₁)=(\tilde{x}ⱼ,\tilde{y}ⱼ)−α·∇_{(\tilde{X}}_{_{j,\tilde{y}j)}} [symbol] (\tilde{x}ⱼ,\tilde{y}ⱼ)

wherein (\tilde{x}ⱼ₊₁, \tilde{y}ⱼ₊₁) represents an optimized (\tilde{x}, \tilde{y}), (\tilde{x}ⱼ, \tilde{y}ⱼ) represents a value of (\tilde{x}, \tilde{y}) upon minimization of the target function, and a represents a learning rate.

In some embodiments, the hyper-parameter A and the learning rate a may be defined as the same value. For example, the hyper-parameter A is defined as 0.1 and the learning rate a is also defined as 0.1. It may be understood that the values of the hyper-parameter and the learning rate are generally empirically adjusted, or may be defined as other values.

Upon a specific number of optimizations, a final optimal reconstructed \tilde{x} is represented by \tilde{x}*, and the reconstructed deep feature of each piece of sample data may be represented by:

E(\tilde{X}):=ƒₙ₊₁(\tilde{x}*)

The number of optimizations may be empirically defined, for example, 5000. Nevertheless, other values larger than 5000 may be defined. In this way, the optimization result is more approximate to the real value; however, the time cost may be increased. Where the number of optimizations is defined as a smaller value, the optimization result is not so approximate to the real value. However, the time cost may be decreased.

Through the above steps, the reconstructed deep feature E(\tilde{X}) of the sample data is acquired. Afterwards, attribute inference may be performed for the sample data X based on the reconstructed deep feature E(\tilde{X}).

It may be understood that S11 to S12 are performed with no need of changing the co-training process, and instead, co-training is normally ongoing. Through S11 to S12, the deep feature of the sample data in each training process involving each of the participating devices is reconstructed, such that attribute inference may be subsequently performed for all the sample data for training.

In S14, the center server stores the assistance data with the attribute label, and a deep feature of the assistance data with the attribute label needs to be first extracted by the feature extractor before training of the attribute inference model ƒₐₜₜᵣ (also referred to as an attribute classification model, the function of which is to recognize and or classify the attributes of the data). Afterwards, the attribute inference model ƒₐₜₜᵣ is trained based on the extracted deep feature of the assistance data with the attribute label, and the attribute of the sample data of the participating device is inferred.

In S15, the center server inputs the reconstructed deep feature of the sample data into the attribute inference model ƒₐₜₜᵣ, such that the attribute of the co-training data is inferred.

Through this step, the attributes of all the sample data involved in model training of the participating devices are inferred.

The sample data and the assistance data include images, and S15 further includes: performing image recognition by image attribution inference on the individual local training sample of the participating device based on the trained attribute inference model ƒₐₜₜᵣ and the reconstructed deep feature. In this way, face recognition or object recognition is achieved.

In summary, according to the embodiments of the present disclosure, the deep feature is reconstructed based on the gradient uploaded by the participating device in co-training, and the attribute of the training data of the participating device in distributed co-training is inferred using the attribute inference model ƒₐₜₜᵣ, such that the attribute of the co-training data is inferred.

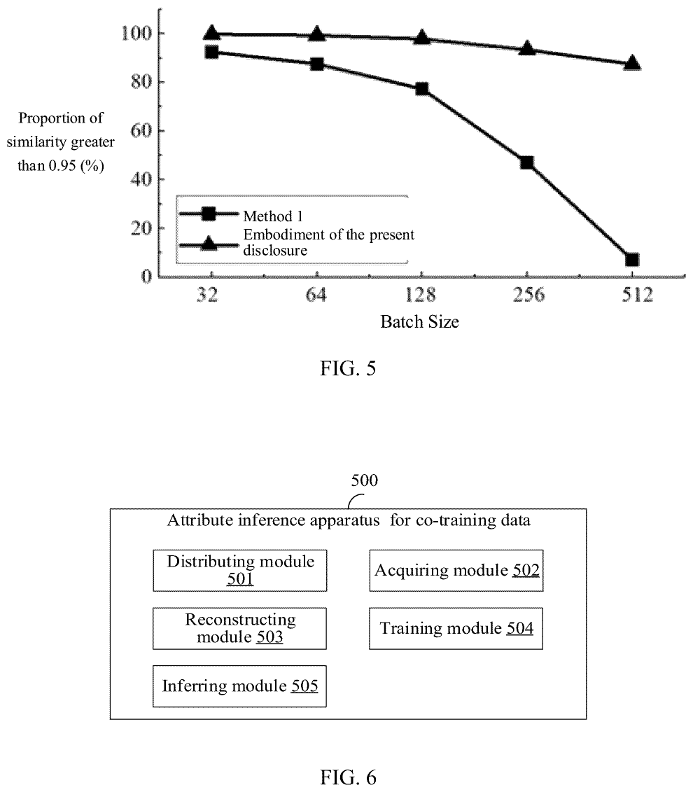

Success rates of deep feature reconstruction under different batch sizes of sample data are statistically collected in the method according to the embodiments of the present disclosure. Specifically, a proportion that the cosine similarity between the reconstructed deep feature and the original real feature is greater than 0.95 is statistically collected. For a comparison result over the related art 1, reference may be made to FIG. 5. FIG. 5 is a schematic statistical diagram of success rates of deep feature reconstruction under different batch sizes of sample data according to the present disclosure and the related art 1 (marked as method 1 in FIG. 5). Apparently, as compared with the related art 1, the method according to the embodiments of the present disclosure achieves a good reconstruction effect on the deep feature under different batch sizes. Particularly, the reconstruction effect in case of large-scale data is prominent and is stable.

Co-training data attribute inference is performed for the first data set, the second data set, and the third data set respectively by using the method according to the embodiments of the present disclosure, the related art 1, and the related art 2.

TABLE 1

| | | | | Embodiments of the |
|---|---|---|---|---|
| Data set | Attribute | Method 1 | Method 2 | present disclosure |
| First | Gender | 87.01 | 92.72 | 95.75 |
| data set | Glasses | 80.14 | 90.96 | 94.64 |
| | Smile | 77.53 | 85.54 | 86.93 |
| | Young | 65.83 | 73.47 | 81.18 |
| Second | Length of | 91.13 | 92.62 | 96.13 |
| data set | the beak | | | |
| Third | Wheel | 66.45 | 68.93 | 75.08 |
| data set | | | | |

Accordingly, the present disclosure improves the accuracy of attribute inference.

In summary, compared with the related art, the embodiments of the present disclosure achieve the following beneficial effects:
(1) The deep feature of the training data is reconstructed by forward propagation and back propagation in the process of training the model, and the deep feature of each piece of data is accurately reconstructed without being affected by the batch size. Compared with reconstruction of the input sample, the reconstruction data amount is small, and the efficiency is high. For example, by reconstruction of the input sample, where the batch size of the sample data reaches 8, the reconstructed deep features are almost not applicable to attribute inference.
(2) The deep features are reconstructed using fewer model structures. Therefore, the reconstruction effect is less affected by the specific model structure, such that the reconstructed deep features are applicable to a plurality of different convolutional neural network models. In this way, the applicability is enhanced.
(3) Compared with the other inference method based on back propagation, by the method for reconstructing the deep feature based on the gradient according to the embodiments of the present disclosure, the deep feature corresponding to each of the training samples is reconstructed and the related attributes of the data are inferred based on the deep features. In this way, the attribute of each piece of the data in small-batch training is inferred, and the inference accuracy is improved. However, by the conventional methods, whether a specific attribute is present in the batch sample data is only inferred; however, the specific sample to which the attribute pertains to fails to be determined, or attribute inference may be performed once for a specific amount of sample data.

FIG. 6 is a schematic structural diagram of an attribute inference apparatus 500 for co-training data according to an embodiment of the present disclosure. As illustrated in FIG. 6, the attribute inference apparatus is applicable to a center server for distributed co-training of a model. The apparatus 500 includes a distributing module 501, an acquiring module 502, a reconstructing module 503, a training module 504, and an inferring module 505.

The distributing module 501 is configured to distribute a pre-trained share model a participating device in distributed co-training, such that the participating device trains and iteratively updates the share model by using batch data of a local sample.

The acquiring module 502 is configured to acquire a first gradient uploaded by the participating device, wherein the first gradient is a gradient that is calculated relative to a model parameter during model training by the participating device.

The reconstructing module 503 is configured to reconstruct a deep feature of the sample data based on the first gradient by using the share model.

The training module 504 is configured to extract a deep feature of assistance data with an attribute label by using the current share model, and train an attribute inference model ƒₐₜₜᵣ, wherein the share model is acquired by co-training and a plurality of iterative updates.

The inferring module 505 is configured to infer a data attribute of an individual local training sample of the participating device based on the trained attribute inference model ƒₐₜₜᵣ and the reconstructed deep feature.

For the specific implementation and operating principle of the apparatus, reference may be made to the above method embodiments, which are thus not described herein any further.

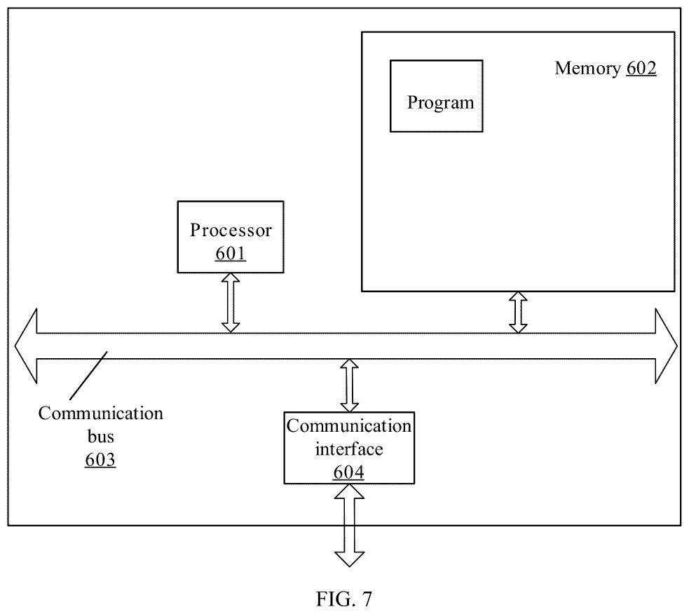

FIG. 7 is a schematic structural diagram of a computing device 600 according to an embodiment of the present disclosure. As illustrated in FIG. 7, the computing device 600 includes a processor 601, a memory 602, a communication interface 603, and a communication bus 604. The processor 601, the communication interface 603, and the memory 602 communicate with each other by the communication bus 604. The memory 602, as a non-volatile computer readable storage medium, may be used to store non-volatile software programs, and non-volatile computer executable programs and modules. In the embodiments of the present disclosure, the memory 602 is configured to store at least one executable instruction, wherein the at least one executable instruction, when loaded and executed by the processor 601, causes the processor to perform the attribute inference method for co-training data as described above.

An embodiment of the present disclosure further provides a computer-readable storage medium. The storage medium stores at least one executable instruction; wherein the executable instruction, when loaded and executed by a processor, causes the processor to perform the operations corresponding to the attribute inference method for co-training data as described above.

Finally, it should be noted that the above embodiments are merely used to illustrate the technical solutions of the present disclosure rather than limiting the technical solutions of the present disclosure. Under the concept of the present disclosure, the technical features of the above embodiments or other different embodiments may be combined, the steps therein may be performed in any sequence, and various variations may be derived in different aspects of the present disclosure, which are not detailed herein for brevity of description. Although the present disclosure is described in detail with reference to the above embodiments, persons of ordinary skill in the art should understand that modifications may still be made to the technical solutions described in the above embodiments, or equivalent replacements may be made to some of the technical features; however, such modifications or replacements do not cause the essence of the corresponding technical solutions to depart from the spirit and scope of the technical solutions of the embodiments of the present disclosure.

What is claimed is:

1. An attribute inference method for co-training data, applicable to a center server for model distributed co-training, the method comprising:
distributing a pre-trained share model to a participating device in distributed co-training, such that the participating device iteratively trains and iteratively updates the share model by using batch data of a local sample, wherein the share model is a neural network model;
acquiring a first gradient uploaded by the participating device, wherein the first gradient is a gradient that is calculated relative to a model parameter during model training by the participating device;
reconstructing a deep feature of the sample data based on the first gradient by using the share model, wherein the deep feature is the variable extracted by the share model;
extracting a deep feature of assistance data with an attribute label by using the share model, and training an attribute inference model ƒₐₜₜᵣ, wherein the share model is acquired by co-training and a plurality of iterative updates; and
inferring a data attribute of an individual local training sample of the participating device based on the trained attribute inference model ƒₐₜₜᵣ and the reconstructed deep feature.

2. The method according to claim 1, wherein reconstructing the deep feature of the sample data based on the first gradient by using the share model comprises:
randomly initializing a first deep feature to be optimized;
acquiring a second gradient by inputting the first deep feature into the share model; and
optimizing the first deep feature by minimizing a difference between the first gradient and the second gradient.

3. The method according to claim 2, wherein the share model is a convolutional neural network model and comprises a feature extractor and a classifier ƒ_{c}, wherein the feature extractor comprises (n+1) convolution blocks; and
acquiring the second gradient by inputting the first deep feature into the share model comprises:
inputting the first deep feature into a last convolution block ƒₙ+₁ of the feature extractor, and inputting a feature E(X) output by the convolution block ƒₙ+₁ into the classifier ƒ_{c};
calculating a gradient \tilde{g}ₙ₊₁ of a parameter of a loss function corresponding to ƒₙ+₁ and a gradient \tilde{g}_{c} of a parameter of the loss function corresponding to ƒ_{c};
wherein the second gradient comprises the gradient \tilde{g}ₙ₊₁ and the gradient \tilde{g}_{c}.

4. The method according to claim 3, wherein the first deep feature is a data pair (\tilde{x}, \tilde{y}), \tilde{x} represents a deep feature to be reconstructed, and \tilde{y} represents a pseudo label.

5. The method according to claim 4, wherein the gradient gₙ₊₁ and the gradient g_{c} are calculated in accordance with the following formula:
\tilde{g}_{c}=∇_{fC} [symbol] _{CE}[ƒ_{c}(ƒₙ₊₁(\tilde{x})),\tilde{y}]
\tilde{g}ₙ₊₁=∇_{ƒ}_{ₙ₊₁} [symbol] _{CE}(ƒₙ+1(\tilde{x}{acute over ())},\tilde{y}
wherein [symbol] _{CE} represents a cross entropy loss function.

6. The method according to claim 5, wherein minimizing the difference between the first gradient and the second gradient comprises:
minimizing a difference between the first gradient and the second gradient by minimizing a target function [symbol] , wherein the target function is: [symbol]
=λ·d(gₙ₊₁,\tilde{g}ₙ₊₁)+d(g_{c},\tilde{g}_{c})
wherein λ represents a hyper-parameter, gₙ₊₁ and g_{c} each represent the first gradient uploaded by the participating device, d(gₙ₊₁, \tilde{g}ₙ+1) and d(g_{c}, \tilde{g}_{c}) each represent a function measuring the difference between two gradients, and a difference between two gradients g and \tilde{g} is measured by a distance function d:
$$d ( g , \tilde{g} ) = ( 1 - \frac{〈 g , \tilde{g} 〉}{‖ g ‖ \cdot ‖ \tilde{g} ‖} ) + ( 1 - exp ( \frac{- {‖ g - \tilde{g} ‖}^{2}}{{σ}^{2}} ) )$$
wherein δ²=Var(g), and Var(g) represents a variance of the gradient g.

7. The method according to claim 6, wherein optimizing the first deep feature comprises:
updating (\tilde{x}, \tilde{y}) in accordance with the following formula:
(\tilde{x}ⱼ₊₁,\tilde{y}ⱼ₊₁)=(\tilde{x}ⱼ,\tilde{y}ⱼ)−α·∇_{(\tilde{x}}_{_{j,}}_{\tilde{y}}_{ⱼ₎} [symbol] (\tilde{x}ⱼ,\tilde{y}ⱼ)
wherein (\tilde{x}ⱼ₊₁, \tilde{y}ⱼ₊₁)represents an optimized (\tilde{x}, \tilde{y}), (\tilde{x}ⱼ, \tilde{y}ⱼ) represents a value of (\tilde{x}, \tilde{y}) upon minimization of the target function [symbol] , and a represents a learning rate.

8. The method according to claim 7, wherein the hyper-parameter λ and the learning rate a are set to the same value.

9. The method according to claim 1, wherein the first gradient is a gradient that is calculated for a model loss in back prorogation, corresponding to a first sample set, relative to the model parameter by the participating device during model training on the first sample set randomly sampled by the participating device; and
reconstructing the deep feature of the sample data based on the first gradient by using the share model comprises:
reconstructing a deep feature of the first sample set based on the first gradient by using the share model.

10. The method according to claim 1, wherein the same data and the assistance data comprises images; and inferring the data attribute of the individual local training sample of the participating device based on the trained attribute inference model ƒₐₜₜᵣ and the reconstructed deep feature comprises:
performing image recognition by image attribution inference on the individual local training sample of the participating device based on the trained attribute inference model ƒₐₜₜᵣ and the reconstructed deep feature.

11. A computing device, comprising: a processor, a memory, a communication interface and a communication bus; wherein the processor, the memory and the communication bus communicate with each other via the communication bus; and
the memory is configured to store at least one executable instruction, wherein the at least one executable instruction, when loaded and executed by the processor, causes the processor to perform the steps of:
distributing a pre-trained share model to a participating device in distributed co-training, such that the participating device iteratively trains and iteratively updates the share model by using batch data of a local sample;
acquiring a first gradient uploaded by the participating device, wherein the first gradient is a gradient that is calculated relative to a model parameter during model training by the participating device;
reconstructing a deep feature of the sample data based on the first gradient by using the share model;
extracting a deep feature of assistance data with an attribute label by using the share model, and training an attribute inference model ƒₐₜₜᵣ, wherein the share model is acquired by co-training and a plurality of iterative updates; and
inferring a data attribute of an individual local training sample of the participating device based on the trained attribute inference model ƒₐₜₜᵣ and the reconstructed deep feature.

12. The computing device according to claim 11, wherein reconstructing the deep feature of the sample data based on the first gradient by using the share model comprises:
randomly initializing a first deep feature to be optimized;
acquiring a second gradient by inputting the first deep feature into the share model; and
optimizing the first deep feature by minimizing a difference between the first gradient and the second gradient.

13. The computing device according to claim 12, wherein the share model is a convolutional neural network model and comprises a feature extractor and a classifier ƒ_{c}, wherein the feature extractor comprises (n+1) convolution blocks; and
acquiring the second gradient by inputting the first deep feature into the share model comprises: inputting the first deep feature into a last convolution block ƒₙ+1 of the feature extractor, and inputting a feature E(X) output by the convolution block ƒₙ+₁ into the classifier ƒ_{c};
calculating a gradient \tilde{g}ₙ₊₁ of a parameter of a loss function corresponding to ƒₙ+₁ and a gradient \tilde{g}_{c} of a parameter of the loss function corresponding to ƒ_{c};
wherein the second gradient comprises the gradient \tilde{g}ₙ₊₁ and the gradient \tilde{g}_{c}.

14. The computing device according to claim 13, wherein the first deep feature is a data pair (\tilde{x}, \tilde{y}), \tilde{x} represents a deep feature to be reconstructed, and \tilde{y} represents a pseudo label.

15. The computing device according to claim 14, wherein the gradient \tilde{g}ₙ₊₁ and the gradient \tilde{g}_{c} are calculated in accordance with the following formula:
\tilde{g}_{c}=∇_{ƒ}_{_{c}} [symbol] _{CE}[ƒ_{c}(ƒₙ₊₁(\tilde{x})),\tilde{y}]
\tilde{g}ₙ₊₁=ƒₙ₊₁ [symbol] _{CE}[ƒ_{c}(ƒₙ₊₁(\tilde{x}),\tilde{y}]
wherein [symbol] _{CE} represents a cross entropy loss function.

16. The computing device according to claim 15, wherein minimizing the difference between the first gradient and the second gradient comprises:
minimizing a difference between the first gradient and the second gradient by minimizing a target function [symbol] , wherein the target function is: [symbol]
=λ−d(gₙ₊₁,\tilde{g}ₙ₊₁)+d(g_{c},\tilde{g}_{c})
wherein λ represents a hyper-parameter, gₙ₊₁ and g_{c} each represent the first gradient uploaded by the participating device, d(gₙ₊₁, \tilde{g}ₙ₊₁) and d(g_{c}, \tilde{g}_{c}) each represent a function measuring the difference between two gradients, and a difference between two gradients g and g is measured by a distance function d:
$$d ( g , \tilde{g} ) = ( 1 - \frac{〈 g , \tilde{g} 〉}{‖ g ‖ \cdot ‖ \tilde{g} ‖} ) + ( 1 - exp ( \frac{- {‖ g - \tilde{g} ‖}^{2}}{{σ}^{2}} ) )$$
wherein δ²=Var(g), and Var(g) represents a variance of the gradient g.

17. The computing device according to claim 16, wherein optimizing the first deep feature comprises:
updating (\tilde{x}, \tilde{y}) in accordance with the following formula:
(\tilde{x}ⱼ₊₁,\tilde{y}ⱼ₊₁)=(\tilde{x}ⱼ,\tilde{Y}ⱼ)−α·∇_{(\tilde{x}}_{_{j,}}_{\tilde{y}}_{ⱼ₎} [symbol] (\tilde{x}ⱼ,\tilde{y}ⱼ)
wherein (\tilde{x}ⱼ₊₁, \tilde{y}ⱼ₊₁)represents an optimized (\tilde{x}, \tilde{y}), (\tilde{x}ⱼ, \tilde{y}ⱼ) represents a value of (\tilde{x}, \tilde{y}) upon minimization of the target function [symbol] , and α represents a learning rate.

18. The computing device according to claim 17, wherein the hyper-parameter A and the learning rate α are set to the same value.

19. The computing device according to claim 11, wherein the first gradient is a gradient that is calculated for a model loss in back prorogation, corresponding to a first sample set, relative to the model parameter by the participating device during model training on the first sample set randomly sampled by the participating device; and
reconstructing the deep feature of the sample data based on the first gradient by using the share model comprises:
reconstructing a deep feature of the first sample set based on the first gradient by using the share model.

20. A computer-readable storage medium, storing at least one executable instruction; wherein the executable instruction, when loaded and executed by a processor, causes the processor to perform the steps of:
distributing a pre-trained share model to a participating device in distributed co-training, such that the participating device iteratively trains and iteratively updates the share model by using batch data of a local sample;
acquiring a first gradient uploaded by the participating device, wherein the first gradient is a gradient that is calculated relative to a model parameter during model training by the participating device;
reconstructing a deep feature of the sample data based on the first gradient by using the share model;
extracting a deep feature of assistance data with an attribute label by using the share model, and training an attribute inference model ƒₐₜₜᵣ, wherein the share model is acquired by co-training and a plurality of iterative updates; and
inferring a data attribute of an individual local training sample of the participating device based on the trained attribute inference model ƒₐₜₜᵣ and the reconstructed deep feature.
